(19) United States
(12) Patent Application Publication
(10) Pub. No.: US 2024/0376401 A1
(43) Pub. Date: Nov. 14, 2024

(54) PHOSPHOROUS-FREE WATER TREATMENT AGENT FOR LAUNDRY APPLICATIONS

(71) Applicant: ECOLAB USA INC., Saint Paul, MN (US)

(72) Inventor: BJOERN PAUTSCH, Monheim am Rhein (DE)

(21) Appl. No.: 18/684,601

(22) PCT Filed: Sep. 1, 2022
(86) PCT No.: PCT/US2022/042288

§ 371 Date: Feb. 16, 2024

(30) Foreign Application Priority Data
Sep. 1, 2021 (EP) 21194274.3

(51) Int. Cl. C11D 3/20; C11D 3/33; C11D 3/37; D06F 35/00

(52) U.S. Cl. CPC C11D 3/2086; C11D 3/33; C11D 3/3765; D06F 35/006; C11D 2111/12

(57) ABSTRACT

Methods and compositions for improving laundry whiteness through the use of phosphorus-free booster compositions are provided to decrease water hardness and heavy metal concentration. The phosphorus-free booster compositions are water treatment agents and methods of using the same provide high quality wash water that has low water hardness and controls heavy metals for improved textile whiteness.

### CROSS REFERENCE TO RELATED APPLICATIONS

This application claims priority under 35 U.S.C. § 111 to European patent application 21194274.3, filed Sep. 1, 2021. The patent application is herein incorporated by reference in its entirety, including without limitation, the specification, claims, and abstract, as well as any figures, tables, appendices, or drawings thereof.

### FIELD OF THE INVENTION

Embodiments disclosed relate to methods and compositions for enhanced laundering through use of phosphorus-free water treatment agents to decrease water hardness and heavy metals concentrations for improved textile whiteness. In particular, methods and compositions for controlling water hardness and transition metal contaminants in water utilized in laundry applications are provided. In an embodiment, non-phosphorous water treatment agents are used as boosters for laundry applications, including professional laundry in need of the excellent textile whiteness.

### BACKGROUND OF THE INVENTION

In professional laundry processes, including commercial or industrial laundry processes, textile materials such as sheets, towels, wipes, garments, tablecloths, etc. are commonly laundered at elevated temperatures with alkaline detergent materials. Such detergent materials typically contain a source of alkalinity. When the linen is treated with an alkaline detergent composition a certain amount of carryover alkalinity may occur. Carryover alkalinity refers to the chemistry that is contained within the linen (that has not been completely removed) that is available for the next step, such as a sour treatment step that uses acid components to neutralize alkalinity, unless all of the detergent use solution is removed by rinsing. The residual components of the alkaline detergents remaining in or on the laundered item can result in decreased whiteness of the fabric, fabric damage or even skin irritation by the wearer of the washed fabric. This is particularly a problem with towels, sheets and garments where fabric whiteness is of great importance.

Another challenge in laundry processes is water quality, in particular iron and other metals in the water. U.S. Publication No. 2018/0371380, which is herein incorporated by reference in its entirety, showed examples of water employed in the wash cycles of a laundry process in various corporate textile care locations consistently have metals, including transition metals, in the water. The most common transition metals found in the water are iron and copper, and they are often present in relatively high amounts, including for example at least about 0.1 ppm, or at least about 0.5 ppm. The sampling indicates the frequency of appearance of transition metals as Fe>Cu>Mn.

These metals, including heavy metals can enter a laundry process from various sources, including water supplied to the washer, direct steam injection heated washers, salt content in new linens, and soil or stains (e.g. rust) providing metal content. Iron can enter the water at the source or be picked up from corroding (or lines in various states of corrosion) water lines and tanks. Iron may be present in water sources in a soluble colorless form called ferrous iron. When exposed to air, ferrous iron rapidly converts to insoluble ferric iron, which can vary in color from yellow to reddish brown. If not properly removed, iron and other metals can cause permanent yellowing of fabrics and loss of fabric life due to tensile strength loss. Metal content can further result in detergent inactivation and/or inhibition, accelerated loss of oxidizing chemistries used in a laundry process, shading due to deposition of metals, as well as shading due to optical brightener modification, and still other detrimental laundry effects.

To date the primary approach to removing metals from water sources utilized in laundry processes focus on water softening equipment to reduce iron impurities. In addition, the approach to remove metals from stains to date has primarily relied upon the use of high levels of caustic, which can damage delicate fabrics and, if not properly removed and brought back to neutral pH, can result in exposure of the caustic to human skin. Current laundry sour compositions to help remove residual alkali and for iron control generally include strong acids such as fluoroacetic acid, phosphoric acid, hydrofluoric acid, and hexafluorosilicic acid which are environmentally undesirable and/or hazardous.

There remains a need in for improved laundering methods for the development of iron and other metal control treatments after alkaline washing that not only prevent yellow staining of laundered fabrics, and remove residual caustic, but also that are environmentally friendly and sustainable. Moreover, there are environmental concerns that necessitate new formulations that do not include phosphorus. These combinations of concerns in laundry applications are further challenged by the need to treat both hardness ions and metals (iron, copper, manganese). It is therefore an object to provide phosphorus-free laundry booster compositions and methods of using the same which provide water hardness, iron and other metal control and whitening that provides at least substantially similar or improved whitening over commercial controls that contain phosphorus and are less environmentally friendly (e.g. phosphorus-containing and/or sour treatment alternatives).

A further object is to provide a non-phosphorous laundry booster composition for the control of water hardness and metals while improving laundry performance.

A further object is to provide methods and phosphorous-free booster compositions for improving laundry whiteness.

A still further object is to provide methods and phosphorous-free booster compositions that provide high quality wash water in the laundry application that has low water hardness and controls heavy metals for improved textile whiteness.

A still further object is to provide methods for laundering wherein the wastewater form the process do not include phosphorus.

Other objects, advantages and features of the present invention will become apparent from the following specification taken in conjunction with the accompanying drawings.

### BRIEF SUMMARY OF THE INVENTION

The methods and compositions according to embodiments disclosed herein beneficially control the damaging effects of water hardness and heavy metals in laundry applications while providing a phosphorus-free booster composition that provides high levels of whitening.

In embodiments methods for treating laundry comprise: contacting the laundry with a laundry booster composition comprising a gluconate chelant, a carboxylate polymer and water: wherein the laundry booster composition is phosphorus-free, controls water hardness and metal contaminants throughout the laundry process, and provides enhanced whiteness of the treated laundry, and wherein the laundry booster compositions follows an initial wash process where the laundry and/or water supplied to the washer is hard water and/or contaminated with metals. In further embodiments the methods further include a rinse cycle following the initial wash process and the laundry booster step. In any of the embodiments, the wastewater from the laundry does not contain phosphorus. In any of the embodiments, the dosing of the laundry booster composition can be provided at a rate of: (a) about 0.5 fluid ounces to about 30 fluid ounces (about 14.79 mL to about 887.1 mL), (b) about 3 fluid ounces to about 30 fluid ounces (about 88.71 mL to about 887.1 mL) per 100 pounds of linen, or (c) at a rate to control at least 0.1 ppm transition metals in the laundry process. In any of the embodiments, the dosing of the laundry booster composition can be provided at a rate of about 0.5 to about 5 grams/L of solution of the water conditioning composition, and wherein the composition comprises from about 0.08 to about 0.8 grams/L gluconate chelant. In any of the embodiments, the contacting of the laundry additive composition can be: before a bleaching and/or oxidizing step in the laundry process; and/or simultaneous with an alkaline detergent wash step in the laundry process.

In additional embodiments, the liquid laundry booster compositions comprise: from about 15 wt-% to about 40 wt-% of a gluconate chelant; from about 25 wt-% to about 50 wt-% of a carboxylate polymer; and from about 20 wt-% to about 50 wt-% of water, wherein the composition is phosphorus-free. In additional embodiments, the gluconate chelant is sodium gluconate or gluconic acid. In any of the embodiments, the carboxylate polymer is a polyacrylate polymer, a polyacrylic acid, a polymaleic acid, salt thereof or combination thereof. In any of the embodiments, the compositions can further comprise an aminocarboxylate chelant. In any of the embodiments, the gluconate chelant comprises from about 15 wt-% to about 30 wt-% of the composition, wherein the carboxylate polymer comprises from about 30 wt-% to about 50 wt-% of the composition, and water comprises from about 20 wt-% to about 40 wt-% of the composition. In additional embodiments, the composition is free of surfactants, phosphorus, and/or diethylenetriaminepentaacetic acid.

While multiple embodiments are disclosed, still other embodiments of the present invention will become apparent to those skilled in the art from the following detailed description, which shows and describes illustrative embodiments of the invention. Accordingly, the drawings and detailed description are to be regarded as illustrative in nature and not restrictive.

### BRIEF DESCRIPTION OF THE DRAWINGS

FIG. 1 shows the results of a raw material screening using the Hempshire test to evaluate calcium complexing capacity of components used in detergent compositions.

FIGS. 2-4 show the results of comparative calcium complexing using the Hempshire test comparing evaluated formulations to various commercial controls.

FIG. 5 shows a graph with the comparative iron complexation capacity of evaluated sequestering agents.

FIG. 6 shows a graph depicting the sequestering power of Fe³⁺ and Cu²⁺.

Various embodiments of the present invention will be described in detail with reference to the drawings, wherein like reference numerals represent like parts throughout the several views. Reference to various embodiments does not limit the scope of the invention. Figures represented herein are not limitations to the various embodiments according to the invention and are presented for exemplary illustration of the invention.

### DETAILED DESCRIPTION OF THE PREFERRED EMBODIMENT

Embodiments disclosed herein relate to methods and laundry booster compositions for controlling the damaging effects of water hardness and metals entering a laundry process while providing desired fabric whitening. The methods and compositions have many advantages over conventional laundry applications, in that water containing metals, such as iron, copper and manganese, along with water hardness ions, can be addressed throughout all phases of the laundry process due to the formulation of the laundry booster compositions. Beneficially, the laundry booster compositions provide soil suspension and removal (such as on cotton fabrics), iron and other metal control, and whitening while also resulting in wastewater that is free of phosphorus.

The embodiments are not limited to particular compositions and methods for laundering, which can vary and are understood by skilled artisans. It is further to be understood that all terminology used herein is for the purpose of describing particular embodiments only, and is not intended to be limiting in any manner or scope. For example, as used in this specification and the appended claims, the singular forms “a,” “an” and “the” can include plural referents unless the content clearly indicates otherwise. Further, all units, prefixes, and symbols may be denoted in its SI accepted form.

Numeric ranges recited within the specification are inclusive of the numbers within the defined range. Throughout this disclosure, various aspects of the methods and compositions are presented in a range format. It should be understood that the description in range format is merely for convenience and brevity and should not be construed as an inflexible limitation on the scope of the invention. Accordingly, the description of a range should be considered to have specifically disclosed all the possible sub-ranges as well as individual numerical values within that range (e.g. 1 to 5 includes 1, 1.5, 2, 2.75, 3, 3.80, 4, and 5).

So that the present invention may be more readily understood, certain terms are first defined. Unless defined otherwise, all technical and scientific terms used herein have the same meaning as commonly understood by one of ordinary skill in the art to which embodiments of the invention pertain. Many methods and materials similar, modified, or equivalent to those described herein can be used in the practice of the embodiments of the present invention without undue experimentation, the preferred materials and methods are described herein. In describing and claiming the embodiments of the present invention, the following terminology will be used in accordance with the definitions set out below.

The term “about,” as used herein, refers to variation in the numerical quantity that can occur, for example, through typical measuring and liquid handling procedures used for making concentrates or use solutions in the real world; through inadvertent error in these procedures; through differences in the manufacture, source, or purity of the ingredients used to make the compositions or carry out the methods; and the like. The term “about” also encompasses amounts that differ due to different equilibrium conditions for a composition resulting from a particular initial mixture. Whether or not modified by the term “about”, the claims include equivalents to the quantities.

The term “actives” or “percent actives” or “percent by weight actives” or “actives concentration” are used interchangeably herein and refers to the concentration of those ingredients involved in cleaning expressed as a percentage minus inert ingredients such as water or salts.

As used herein, the term “cleaning” refers to a method used to facilitate or aid in soil removal, bleaching, microbial population reduction, rinsing, and any combination thereof. As used herein, the term “microorganism” refers to any noncellular or unicellular (including colonial) organism. Microorganisms include all prokaryotes. Microorganisms include bacteria (including cyanobacteria), spores, lichens, fungi, protozoa, virinos, viroids, viruses, phages, and some algae. As used herein, the term “microbe” is synonymous with microorganism.

The terms “include” and “including” when used in reference to a list of materials refer to but are not limited to the materials so listed.

The term “laundry” refers to items or articles that are cleaned in a laundry washing machine. In general, laundry refers to any item or article made from or including textile materials, woven fabrics, non-woven fabrics, and knitted fabrics. The textile materials can include natural or synthetic fibers such as silk fibers, linen fibers, cotton fibers, polyester fibers, polyamide fibers such as nylon, acrylic fibers, acetate fibers, and blends thereof including cotton and polyester blends. The fibers can be treated or untreated. Exemplary treated fibers include those treated for flame retardancy. It should be understood that the term “linen” is often used to describe certain types of laundry items including bed sheets, pillowcases, towels, table linen, tablecloth, bar mops and uniforms.

The term “linen” refers to items or articles that are cleaned in a laundry washing machine. In general, linen refers to any item or article made from or including textile materials, woven fabrics, non-woven fabrics, and knitted fabrics. The textile materials can include natural or synthetic fibers such as silk fibers, linen fibers, cotton fibers, polyester fibers, polyamide fibers such as nylon, acrylic fibers, acetate fibers, and blends thereof including cotton and polyester blends. The fibers can be treated or untreated. Exemplary treated fibers include those treated for flame retardancy. It should be understood that the term “linen” is often used to describe certain types of linen items including bed sheets, pillowcases, towels, table linen, tablecloth, bar mops and uniforms.

As used herein, the term “phosphate-free” refers to a composition, mixture, or ingredient that does not contain a phosphate or phosphate-containing compound or to which a phosphate or phosphate-containing compound has not been added. Should a phosphate or phosphate-containing compound be present through contamination of a phosphate-free composition, mixture, or ingredients, the amount of phosphate shall be less than 0.5 wt %. More preferably, the amount of phosphate is less than 0.1 wt-%, and most preferably, the amount of phosphate is less than 0.01 wt %. In an aspect, the laundry booster compositions are phosphate-free and contain 0 wt-% phosphate.

As used herein, the term “phosphorus-free” refers to a composition, mixture, or ingredient that does not contain phosphorus or a phosphorus-containing compound or to which phosphorus or a phosphorus-containing compound has not been added. Should phosphorus or a phosphorus-containing compound be present through contamination of a phosphorus-free composition, mixture, or ingredients, the amount of phosphorus shall be less than 0.5 wt %. More preferably, the amount of phosphorus is less than 0.1 wt-%, and most preferably the amount of phosphorus is less than 0.01 wt %. In an aspect, the laundry booster compositions are phosphorus-free and contain 0 wt-% phosphorus.

The term “soft surface” refers to a resilient cleanable substrate, for example materials made from woven, nonwoven or knit textiles, leather, rubber or flexible plastics including fabrics (for example surgical garments, draperies, bed linens, bandages, etc.), carpet, transportation vehicle seating and interior components and the like.

As used herein, the term “soil” refers to polar or non-polar organic or inorganic substances including, but not limited to carbohydrates, proteins, fats, oils and the like. These substances may be present in their organic state or complexed to a metal to form an inorganic complex.

As used herein, the term “stain” refers to a polar or non-polar substance which may or may not contain particulate matter such as metal oxides, metal hydroxides, metal oxide-hydroxides, clays, sand, dust, natural matter, carbon black, graphite and the like

As used herein, the term “substantially free” refers to compositions completely lacking the component or having such a small amount of the component that the component does not affect the performance of the composition. The component may be present as an impurity or as a contaminant and shall be less than 0.5 wt-%. In another embodiment, the amount of the component is less than 0.1 wt-% and in yet another embodiment, the amount of component is less than 0.01 wt-%.

The term “substantially similar cleaning performance” refers generally to achievement by a substitute cleaning product or substitute cleaning system of generally the same degree (or at least not a significantly lesser degree) of cleanliness or with generally the same expenditure (or at least not a significantly lesser expenditure) of effort, or both.

The term “weight percent,” “wt-%,” “percent by weight,” “% by weight,” and variations thereof, as used herein, refer to the concentration of a substance as the weight of that substance divided by the total weight of the composition and multiplied by 100. It is understood that, as used here, “percent,” “%,” and the like are intended to be synonymous with “weight percent,” “wt-%,” etc.

The methods, systems, and compositions may comprise, consist essentially of, or consist of the components and ingredients as well as other ingredients described herein. As used herein, “consisting essentially of” means that the methods, systems, and compositions may include additional steps, components or ingredients, but only if the additional steps, components or ingredients do not materially alter the basic and novel characteristics of the claimed methods, systems, and compositions.

It should also be noted that, as used in this specification and the appended claims, the term “configured” describes a system, apparatus, or other structure that is constructed or configured to perform a particular task or adopt a particular configuration. The term “configured” can be used interchangeably with other similar phrases such as arranged and configured, constructed and arranged, adapted and configured, adapted, constructed, manufactured and arranged, and the like.

### Methods of Use

The laundry booster compositions and methods disclosed herein are suitable for improving laundry applications and performance. In particular, the compositions and methods disclosed herein are suitable for controlling water hardness and transition metal contaminants to improve quality throughout the laundry process, including for example improved detergency, improved bleaching and wastewater operations that are phosphorus-free. Without being limited to a particular mechanism of action, the use of the phosphorous-free laundry booster compositions controls the detrimental presence of transition metal contaminants in water sources employed throughout a laundry application.

The laundry booster compositions are suitable for use in conditioning water sources and soils contaminating a laundry process. Beneficially, the laundry booster compositions and methods of use thereof control transition metal contaminants throughout the laundry process. For example, transition metal contaminants can be introduced through multiple sources, which conventional detergents do not fully overcome. In an aspect, the laundry process includes an initial wash process utilizing transition metal contaminated water supplied to the washer. In a further aspect, the laundry process comprises an initial wash process utilizing transition metal contaminated soils or laundry supplied to the washer. In a still further aspect, the laundry process comprises a steaming or direct steam injection contaminated with transition metals to heat waters utilized in the laundry process. In a further aspect, a laundry process includes one or more of these steps which can detrimentally introduce metal contaminants into a laundry process.

The dosing of the laundry booster composition can be provided to one or more inputs of the laundry process. Preferably, the laundry booster composition is dosed into a washing machine in a wash cycle.

As one skilled in the art will ascertain based on the disclosure provided herein, the dosing rates of the laundry booster compositions can vary based upon the degree of water hardness and metal contamination of the laundry process. In an aspect, contamination can be measured by the presence of one or more of iron, copper and/or manganese. In further aspects, contamination can also be measured by the presence of one of more of alkaline earth metals, such as calcium and magnesium which are common contaminants in water hardness. In a further aspect, the contamination is preferably measured by the presence of iron. In a further aspect, the contamination can be measured by the presence of at least 0.1 ppm, at least 0.2 ppm, at least 1 ppm, or at least 10 ppm of iron or another transition metal contaminant or alkaline earth metal contaminant. Accordingly an initial step of the methods disclosed herein can optionally comprise a measuring or detecting step, or a means for detecting, to determine contamination with any contaminants, such as water hardness and/or transition metals and optionally alkaline earth metals.

In an aspect, the dosing of the laundry booster composition is provided at a rate of about 0.5 to about 30 fluid ounces (about 14.79 mL to about 887.1 mL) per 100 pounds of linen, about 3 to about 30 fluid ounces (about 88.71 mL to about 887.1 mL) per 100 pounds of linen, about 5 to about 30 fluid ounces (about 147.9 mL to about 887.1 mL) per 100 pounds of linen, about 10 to about 30 fluid ounces (about 295.8 mL to about 887.1 mL) per 100 pounds of linen, about 5 to about 25 fluid ounces (about 147.9 mL to about 739.5 mL) per 100 pounds of linen, or about 5 to about 20 fluid ounces (about 147.9 mL to about 591.6 mL) per 100 pounds of linen. In another aspect, the dosing of the laundry booster composition is provided at a rate to control transition metals contained at a concentration of at least about 0.1 ppm in a laundry process.

In an aspect, the dosing of the laundry booster composition is provided at a rate of about 0.1 to about 5 grams/L, or preferably about 0.5 to about 1 grams/L of solution of the laundry booster composition.

In an aspect, the laundry booster composition control iron and other metals (including both transition metals and alkaline earth metals) across all stages or steps of the laundry process. Beneficially, the laundry booster compositions unexpectedly achieve the same stability (i.e. survivability or the ability of chelants to survive in the pH range while continuing to capture the transition metals) due to the combination of the gluconate chelant (particularly suitable for high pH), and carboxylate polymers (particularly suitable for oxidizing conditions). In an aspect, the laundry booster composition beneficially controls the iron and other metal contaminants at a pH between about 5 to about 12, or preferably from about 6 to about 12 providing efficacy over acid, neutral and alkaline pHs.

In an aspect, the dosing of the laundry booster composition takes place before, simultaneously with, or after an initial alkaline detergent step (also referred to as a break step) in a laundry process. In a preferred embodiment, the dosing of the laundry booster composition takes place after the alkaline detergent step in a laundry process. In a preferred method, the dosing of the laundry booster composition takes place simultaneously with an alkaline detergent wash step in a laundry process.

In an aspect, the dosing of the laundry booster composition takes place before, simultaneously with, or after a bleaching (and/or oxidizing) step in a laundry process. In a preferred embodiment, the dosing of the laundry booster composition takes place before a bleaching (or oxidizing) step in a laundry process. As one skilled in the art will ascertain, treatment of a laundry bleach and/or oxidizing bath (including both chlorine based or oxygen based) is complex in that transition metals and turbidity need to be managed to optimize bleaching efficiency, presenting additional challenges.

In an aspect, the dosing of the laundry booster composition takes place before, simultaneously with, or after a sour step in a laundry process. In a preferred embodiment, the dosing of the laundry booster composition takes place before a sour step in a laundry process.

In some embodiments, the dosing of the laundry booster composition takes place in a laundry system having a direct steam injection having increased contamination as a result of the heating system.

The methods of using the laundry booster compositions according to the embodiments provide additional benefits, including improved cleaning results on various linens and surfaces, and enhanced removal of stains.

### Embodiments

Exemplary ranges of the laundry booster compositions are shown in Table 1 in weight percentage of a concentrate liquid composition. Laundry compositions are generally referred to as a liquid concentrates as they are further diluted upon dosing to a laundry application where additional water is present to dilute the concentrate composition.

TABLE 1

| | First | Second | Third | Fourth |
|---|---|---|---|---|
| | Exemplary | Exemplary | Exemplary | Exemplary |
| | Range | Range | Range | Range |
| Material | wt-% | wt-% | wt-% | wt-% |
| Water | 20-50 | 20-40 | 20-35 | 25-35 |
| Gluconic Acid or | 15-40 | 15-30 | 20-30 | 25-30 |
| Gluconate salt chelant | | | | |
| Polymer | 25-50 | 30-50 | 35-50 | 40-50 |
| Additional Functional | 0-20 | 0-15 | 0-10 | 0-5 |
| Ingredients | | | | |

The laundry booster compositions may include concentrate compositions or may be diluted to form use compositions. In general, a concentrate refers to a composition that is intended to be diluted with water to provide a use solution that contacts an object to provide the desired cleaning, rinsing, or the like. The laundry booster composition that contacts the water to be treated to control water hardness and transition metal contaminants can be referred to as a concentrate or a use composition (or use solution) dependent upon the formulation employed in methods. A use solution may be prepared from the concentrate by diluting the concentrate with water at a dilution ratio that provides a use solution having desired laundry booster properties. The water that is used to dilute the concentrate to form the use composition can be referred to as water of dilution or a diluent, and can vary from one location to another. The typical dilution factor is between approximately 1 and approximately 10,000 but will depend on factors including concentration of transition metal contaminants and the like. In an embodiment, the concentrate is diluted at a ratio of between about 1:10 and about 1:10,000 concentrate to water. Particularly, the concentrate is diluted at a ratio of between about 1:10 and about 1:1,000 concentrate to water. More particularly, the concentrate is diluted at a ratio of between about 1:10 and about 1:100 concentrate to water.

### Laundry Booster Compositions

The laundry booster compositions beneficially provide soil suspension and removal (such as on cotton fabrics and other laundry substrates) and effective whitening of the fabrics and substrates, and iron and other transition metal and alkaline earth metal control allowing the composition to be used throughout the laundry process. Without being limited to a particular mechanism of action, the laundry booster compositions complex ions of heavy metals and calcium to provide the whitening and color retention on treated surfaces. Moreover, the laundry booster compositions counteract the increase in weight on treated surfaces due to deposits, which beneficially prevents a change in the textile feel, protects against graving and also prevents a superimposition of dirt and thus poorer removal. These benefits are further described and shown in the description of the invention.

The laundry booster compositions are not detergent compositions as they do not contain surfactants. In an aspect, the laundry booster compositions comprise, consist of and/or consist essentially of a gluconate chelant, a carboxylate polymer, and water, wherein the compositions are phosphorus-free. In a further aspect, the laundry booster compositions comprise, consist of and/or consist essentially of a gluconate chelant, a carboxylate polymer, water, and additional functional ingredient(s), wherein the compositions are phosphorus-free.

### Gluconate Chelant

The laundry booster compositions include a gluconate chelant, including a gluconate salt or gluconic acid chelant. Gluconic acids can be employed but do not provide a 100% active compound. Gluconate salts can also be employed. In an exemplary embodiment, the gluconate salt chelant is sodium gluconate. Without being limited to a particular mechanism of action, sodium gluconate provides a benefit in having a greater affinity to the transition metals iron and copper, and moreover provides a 100% active compound for including in the laundry booster compositions. Sodium gluconate can optionally be combined with additional chelants. The additional chelants are selected as having preferred affinity for additional transition metal contaminants and/or traditional water hardness ions.

In some embodiments, the gluconic acid or sodium gluconate (or other salt form) chelant is effective for treating the majority of the heavy or transition metal contaminant concentrations and does not require combination with a secondary chelant. In some embodiments no additional chelant is included in the laundry booster composition. Beneficially, the use of the gluconate chelant as the strong phosphorus-free chelant provides the environmental benefits as described herein as well.

In an aspect, the compositions include from about 15 wt-% to about 40 wt-% gluconic acid chelant, from about 15 wt-% to about 30 wt-% gluconic acid chelant, from about 20 wt-% to about 30 wt-% gluconic acid chelant, or preferably from about 25 wt-% to about 30 wt-% gluconic acid chelant. In an aspect, the compositions include from about 15 wt-% to about 40 wt-% gluconate salt chelant, from about 15 wt-% to about 30 wt-% gluconate salt chelant, from about 20 wt-% to about 30 wt-% gluconate salt chelant, or preferably from about 25 wt-% to about 30 wt-% gluconate salt chelant. In addition, without being limited according to the compositions, all ranges recited are inclusive of the numbers defining the range and include each integer within the defined range.

### Carboxylate Polymer

The laundry booster compositions include a carboxylate polymer. Carboxylate polymers which include polymers or copolymers of acrylic acid or maleic acid, and further includes substituted or functionalized analogs of the same.

In an aspect the carboxylate polymer is a polyacrylate polymer, including polyacrylic acid polymers, preferably low molecular weight acrylate polymers. Polyacrylic acid homopolymers can contain a polymerization unit derived from the monomer selected from the group consisting of acrylic acid, methacrylic acid, methyl acrylate, methyl methacrylate, ethyl acrylate, ethyl methacrylate, butyl acrylate, butyl methacrylate, iso-butyl acrylate, iso-butyl methacrylate, iso-octyl acrylate, iso-octyl methacrylate, cyclohexyl acrylate, cyclohexyl methacrylate, glycidyl acrylate, glycidyl methacrylate, hydroxyethyl acrylate, hydroxypropyl acrylate, 2-hydroxyethyl acrylate, 2-hydroxyethyl methacrylate, 2-hydroxypropyl acrylate, 2-hydroxypropyl methacrylate, and hydroxypropyl methacrylate and a mixture thereof, among which acrylic acid. methacrylic acid, methyl acrylate, methyl methacrylate, butyl acrylate, butyl methacrylate, iso-butyl acrylate, iso-butyl methacrylate, hydroxyethyl acrylate, 2-hydroxyethyl acrylate, 2-hydroxyethyl methacrylate, 2-hydroxypropyl acrylate, and 2-hydroxypropyl methacrylate, and a mixture thereof are preferred.

Preferred are polyacrylic acids, (C₃H₄O₂)ₙ or 2-Propenoic acid homopolymers; Acrylic acid polymer; Poly(acrylic acid); Propenoic acid polymer; PAA have the following structural formula:

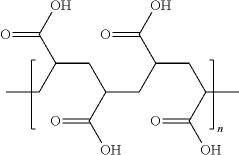

where n is any integer.

One source of commercially available polyacrylates (polyacrylic acid homopolymers) useful for the compositions includes the Acusol 445 series from The Dow Chemical Company, Wilmington Delaware, USA, including, for example, Acusol® 445 (acrylic acid polymer, 48% total solids) (4500 MW), Acusol® 445N (sodium acrylate homopolymer, 45% total solids) (4500 MW), and Acusol®445ND (powdered sodium acrylate homopolymer, 93% total solids) (4500 MW) Other polyacrylates (polyacrylic acid homopolymers) commercially available from Dow Chemical Company suitable for the compositions include, but are not limited to Acusol 929 (10,000 MW) and Acumer 1510. Yet another example of a commercially available polyacrylic acid is AQUATREAT AR-6 (100,000 MW) from AkzoNobel. Other suitable polyacrylates (polyacrylic acid homopolymers) for use in the compositions include, but are not limited to those obtained from additional suppliers such as Aldrich Chemicals, Milwaukee, Wis., and ACROS Organics and Fine Chemicals, Pittsburgh, Pa, BASF Corporation and SNF Inc. Additional disclosure of polyacrylates suitable for use in the solid rinse aid compositions is disclosed in U.S. Application Ser. No. 62,043,572 which is herein incorporated by reference in its entirety.

Polymaleic acid (C₄H₂O₃)x polymers or hydrolyzed polymaleic anhydride or cis-2-butenedioic acid homopolymer, has the structural formula:

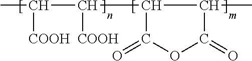

where n and m are any integer. Preferred polymaleic acid polymers which may be used for the compositions those with a molecular weight of about 400-800. Commercially available polymaleic acids include the Belclene 200 series of maleic acid homopolymers.

The carboxylate polymers used in the laundry booster compositions are phosphorus-free and provide the best performance for phosphorus-free water hardness (as shown in examples by calcium binding capacity) control in laundry applications.

In an aspect, the compositions include from about 25 wt-% to about 50 wt-% carboxylate polymer, from about 30 wt-% to about 50 wt-% carboxylate polymer, from about 35 wt-% to about 50 wt-% carboxylate polymer, from about 35 wt-% to about 45 wt-% carboxylate polymer, or from about 40 wt-% to about 50 wt-% carboxylate polymer. In addition, without being limited according to the compositions, all ranges recited are inclusive of the numbers defining the range and include each integer within the defined range.

### Water

The laundry booster compositions can be provided as liquid compositions containing water. The water source employed should be free of transition metals so as not to introduce any contaminants into the laundry process. In an aspect, the compositions include from about 20 wt-% to about 50 wt-% water, from about 20 wt-% to about 40 wt-% water, from about 20 wt-% to about 35 wt-% water, or preferably from about 25 wt-% to about 35 wt-% water. In addition, without being limited, all ranges recited are inclusive of the numbers defining the range and include each integer within the defined range. As one skilled in the art will ascertain the concentration of water in the laundry booster compositions can be adjusted to provide concentrate compositions and/or solid compositions.

### Additional Functional Ingredients

The components of the laundry booster compositions can further be combined with various functional components suitable for use in laundry applications. In some embodiments, the laundry booster compositions including the gluconate chelants, polymer and water which make up a large amount, or even substantially all of the total weight of the composition. For example, in some embodiments few or no additional functional ingredients are disposed therein.

In other embodiments, additional functional ingredients may be included in the compositions. The functional ingredients provide desired properties and functionalities to the compositions. For the purpose of this application, the term “functional ingredient” includes a material that when dispersed or dissolved in a use and/or concentrate solution, such as an aqueous solution, provides a beneficial property in a particular use. Some particular examples of functional materials are discussed in more detail below, although the particular materials discussed are given by way of example only, and that a broad variety of other functional ingredients may be used.

In preferred embodiments, the compositions do not include phosphonates. In further preferred embodiments, the compositions do not include additional chelants. In further preferred embodiments, the compositions do not include a diethylenetriaminepentaacetic acid chelant.

In other embodiments, the compositions may include an additional chelant, anti-redeposition agents, bleaching agents, solubility modifiers, dispersants, metal protecting agents, stabilizing agents, corrosion inhibitors, fragrances and/or dyes, alkalinity sources, rheology modifiers or thickeners, hydrotropes or couplers, buffers, solvents and the like. In an aspect the compositions may include additional pH modifiers, including alkalinity agents, such as for example, hydroxides, carbonates, silicates, and the like. In embodiments herein the additional functional ingredients are phosphorus-free.

In embodiments including additional functional ingredient(s), the compositions include up to 20 wt-%, up to 15 wt-%, up to 10 wt-%, or up to 5 wt-% additional functional ingredient(s). In embodiments the booster compositions include from about 0-20 wt-% additional functional ingredient(s), 0-15 wt-% additional functional ingredient(s), 0-10 wt-% additional functional ingredient(s), or 0-5 wt-% additional functional ingredient(s). In addition, without being limited according to the compositions, all ranges recited are inclusive of the numbers defining the range and include each integer within the defined range.

### Additional Chelants

The laundry booster compositions do not require but can optionally include at least one additional chelant. Chelants include chelating agents (chelators), sequestering agents (sequestrants), builders, and the like. Examples of chelants include, but are not limited to, phosphonates, phosphates, aminocarboxylates and their derivatives, pyrophosphates, polyphosphates, ethylenediamine and ethylenetriamine derivatives, hydroxyacids, and mono-, di-, and tri-carboxylates and their corresponding acids. Other exemplary chelants include aluminosilicates, nitroloacetates and their derivatives, and mixtures thereof. Still other exemplary chelants include aminocarboxylates, including salts of methyl glycine diacetic acid (MGDA, commercially available as Trilon M), ethylenediaminetetraacetic acid (EDTA) (including tetra sodium EDTA), hydroxyethylenediaminetetraacetic acid (HEDTA), and diethylenetriaminepentaacetic acid (DTPA). Chelants can be water soluble, and/or biodegradable. Other exemplary chelants include TKPP (tetrapotassium pyrophosphate), PAA (polyacrylic acid) and its salts, phosphonobutane carboxylic acid, Alanine, N,N-bis(carboxymethyl)-trisodium salt, and sodium gluconate. As described herein, only phosphorus-free chelants are suitable for use with the laundry booster composition.

Additional chelants include amino polycarboxylates, including but not limited to diethylene triamine pentaacetate, diethylene triamine penta(methyl phosphonic acid), ethylene diamine-N′N′-disuccinic acid, ethylene diamine tetraacetate, ethylene diamine tetra(methylene phosphonic acid) and hydroxyethane di(methylene phosphonic acid). Preferably the chelating agent is a biodegradable aminopolycarboxylate such as glutamic acid (GLDA), methylglycinediacetic acid (MGDA), L-aspartic acid N,N-diacetic acid tetrasodium salt (ASDA), DEG/HEIDA (sodium diethanolglycine/2-hydroxyethyliminodiacetic acid, disodium salt), iminodisuccinic acid and salts (IDS), and ethylenediaminedisuccinic acid and salts (EDDS).

In some embodiments, the additional one or more chelant(s) is substantially free of phosphorus. In more preferred embodiments, the additional one or more chelants is free of phosphorus. Preferably, the chelant is a sodium salt of aminocarboxylates. More preferably, the chelant is methyl glycine diacetic acid.

In an aspect, the compositions include from about 0 wt-% to about 10 wt-% additional chelant, from about 0) wt-% to about 5 wt-% additional chelant, or from about 1 wt-% to about 10 wt-% additional chelant, or from about 1 wt-% to about 5 wt-% additional chelant. In addition, without being limited according to the compositions, all ranges recited are inclusive of the numbers defining the range and include each integer within the defined range.

All publications and patent applications in this specification are indicative of the level of ordinary skill in the art to which this invention pertains. All publications and patent applications are herein incorporated by reference to the same extent as if each individual publication or patent application was specifically and individually indicated as incorporated by reference.

### Embodiments of the Disclosure

The application refers to the following aspects:

1. A method for treating laundry comprising:
contacting the laundry with a laundry booster composition comprising a gluconate chelant, a carboxylate polymer and water;
wherein the laundry booster composition is phosphorus-free, controls water hardness and metal contaminants throughout the laundry process, and provides enhanced whiteness of the treated laundry, and
wherein the laundry booster compositions follows an initial wash process where the laundry is contaminated with metals and/or water supplied to the washer is hard water and/or is contaminated with metals.

2. The method of aspect 1, further comprising a rinse cycle following the initial wash process and the laundry booster step.

3. The method of any one of aspects 1-2, wherein the wastewater from the laundry does not contain phosphorus.

4. The method of any one of aspects 1-3, wherein the gluconate chelant is a gluconate salt or gluconic acid.

5. The method of any one of aspects 1-4, wherein the carboxylate polymer is a polyacrylic acid or polymaleic acid.

6. The method of any one of aspects 1-5, wherein the laundry booster composition further comprises an aminocarboxylate chelant.

7. The method of any one of aspects 1-5, wherein the laundry booster composition consists of the gluconate chelant, the carboxylate polymer and water.

8. The method of any one of aspects 1-7, wherein the dosing of the laundry booster composition is provided at a rate of: (a) about 0.5 fluid ounces to about 30 fluid ounces (about 14.79 mL to about 887.1 mL), (b) about 3 fluid ounces to about 30 fluid ounces (about 88.71 mL to about 887.1 mL) per 100 pounds of linen, or (c) at a rate to control at least 0.1 ppm transition metals in the laundry process.

9. The method of any one of aspects 1-8, wherein the dosing of the laundry booster composition is provided at a rate of about 0.5 to about 5 grams/L of solution of the water conditioning composition, and wherein the composition comprises from about 0.08 to about 0.8 grams/L gluconate chelant.

10. The method of any one of aspects 1-9, wherein the laundry booster composition is dosed into the washing machine.

11. The method of any one of aspects 1-10, wherein the contacting of the laundry additive composition is: before a bleaching and/or oxidizing step in the laundry process; and/or simultaneous with an alkaline detergent wash step in the laundry process.

12. A liquid laundry booster composition comprising:
from about 15 wt-% to about 40 wt-% of a gluconate chelant;
from about 25 wt-% to about 50 wt-% of a carboxylate polymer; and
from about 20 wt-% to about 50 wt-% of water,
wherein the composition is phosphorus-free.

13. The composition of aspect 12, wherein the gluconate chelant is sodium gluconate or gluconic acid.

14. The composition of any one of aspects 12-13, wherein the carboxylate polymer is a polyacrylate polymer, a polyacrylic acid, a polymaleic acid, salt thereof or combination thereof.

15. The composition of any one of aspects 12-14, further comprising an aminocarboxylate chelant.

16. The composition of aspect 15, wherein the aminocarboxylate chelant is methyl glycine diacetic acid.

17. The composition of any one of aspects 12-14, wherein no additional chelants are included in the composition.

18. The composition of any one of aspects 12-17, wherein the gluconate chelant comprises from about 15 wt-% to about 30 wt-% of the composition, wherein the carboxylate polymer comprises from about 30 wt-% to about 50 wt-% of the composition, and water comprises from about 20 wt-% to about 40 wt-% of the composition.

19. The composition of any one of aspects 12-18, wherein the composition is free of surfactants, phosphorus, and/or diethylenetriaminepentaacetic acid.

20. A liquid laundry booster composition consisting of:
from about 15 wt-% to about 40 wt-% of a gluconate chelant;
from about 25 wt-% to about 50 wt-% of a carboxylate polymer; and
from about 20 wt-% to about 50 wt-% of water,
wherein the composition is phosphorus-free.

### EXAMPLES

Embodiments of the present invention are further defined in the following non-limiting Examples. It should be understood that these Examples, while indicating certain embodiments of the invention, are given by way of illustration only. From the above discussion and these Examples, one skilled in the art can ascertain the essential characteristics of this invention, and without departing from the spirit and scope thereof, can make various changes and modifications of the embodiments of the invention to adapt it to various usages and conditions. Thus, various modifications of the embodiments of the invention, in addition to those shown and described herein, will be apparent to those skilled in the art from the foregoing description. Such modifications are also intended to fall within the scope of the appended claims.

### Example 1

Initial pretesting was conducted for baseline whiteness (Y-Value) assessment. Secondary wash test on a small laboratory washing machine (Lini test device) in the presence of a mixture of heavy metals (4.95 ppm Fe: 0.99 ppm Mn: 0.198 ppm Cu) was conducted using the formulas in Table 2A and a Control Benchmark shown in Table 2B, and results are shown in Table 2C. The evaluated formulations increased the polyacrylic acid, removed the phosphate/phosphonic acids and modified the water hardness/chelant in comparison to the Benchmark Control. It is desired to provide at least substantially equivalent cleaning and whitening of the laundry to the Control that contains phosphorus.

TABLE 2A

| | Wt-% | | | |
|---|---|---|---|---|
| Component | Formula 1 | Formula 2 | Formula 3 | Formula 4 |
| Water softened | 61 | 56 | 51 | 40 |
| Methyl glycine | 5 | 5 | 5 | 5 |
| diacetic acid (MGDA) | | | | |
| Polyacrylic acid | 18 | 21 | 24 | 30 |
| sodium salt | | | | |
| Sodium gluconate | 16 | 18 | 20 | 25 |
| Total | 100% | 100% | 100% | 100% |

TABLE 2B
Control Benchmark 1

| Component | Wt-% |
|---|---|
| Water softened | 51.5% |
| Phosphoric acid | 3.5% |
| Dequest 2066 (HEDP; | 35% |
| Hydroxyethylidene diphosphonic acid) | |
| Polyacrylic acid sodium salt | 10% |
| Total | 100% |

TABLE 2C
Y-Value after 5 wash cycles of cotton textile

| | Y-Value |
|---|---|
| Benchmark 1 | 84.85 |
| Formula 1 | 81.62 |
| Formula 2 | 82.73 |
| Formula 3 | 83.02 |
| Formula 4 | 83.56 |

Basic whiteness value (Y-value) refers to a reflectance value calculated a spectrophotometer. Y-value indicates the degree of whiteness after the UV component of the light source has been filtered out and the brightening effect on the clean laundry has been erased. The Y-value is important for detecting graying, discoloration, color carryover or other textile changes. In general, the Y-value of 87 should not be fallen short of after 50 wash cycles. The document RAL Sachgem\ddot{α}βe Wäschepflege-Gütesicherung RAL-GZ992. May 2019. German Institute for Quality Assurance and Certification e. V. defines the Y-value and its measurement. The document also refers to DIN 5033. The Y-value is measured directly with Spectrophotometer CM-3610A from KONICA MINOLTA.

The results demonstrate that the whiteness degree (Y-Value) is on highest level for Formula 4, containing the greatest amount of Na-Gluconate (25%) and Acusol 445N (30%) in evaluated formulations. The difference in performance of Formula 4 and Benchmark Control is small and not significant.

### Example 2

Hempshire testing was completed to assess calcium (Ca) complexing or binding capacity in order to evaluate the performance against water hardness. The Hampshire method is the best-known method for determining calcium binding capacity and is well recognized in the detergent industry as a test for incrustation inhibitors in laundry detergents. In both calcium binding as well as turbidity titration methods they are used to measure the quantity of calcium ions complexed per unit of complexing agent. Results are expressed as the quantity of bound calcium carbonate. The methods employed are as follows:

### Equipment and Reagent:

150 ml beaker glass
2% Na₂CO₃-Solution
1 mol/L NaOH-Solution
0.25 mol/L (CH₃COO)₂Ca-Solution
Titration equipment

Testing: Weigh in the beaker glass 1 g of the complexing agent and dissolve with 100 mL distillation water. 10 mL of a 2% Sodium Carbonate solution was then added and adjusted with NaOH to pH 11 (pH constant during the titration). The solution was then titrated with a 0.25 mol/L Calcium Acetate solution until lasting turbidity is observed. The Calculation of the calcium binding capacity result for raw material (as it is) is as follows:

ml(CH₃COO)₂Ca·25/Weight(g)=mg CaCO₃/g Complexing agent

To calculate calcium binding capacity of the dry activity of a raw material (RM) it is calculated as follows:

mg CaCO₃/RM*100=mgCaCO₃/g Complexing agent active

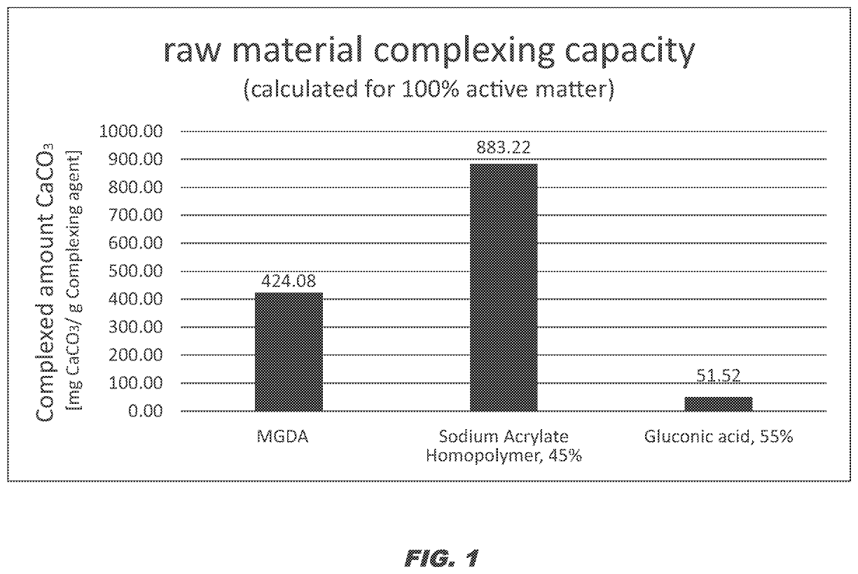

First a raw material screening was conducted comparing 100% active matter for the chelant Trilon M (methyl glycine diacetic acid (MGDA)), Acusol 445N (the carboxylate polymer sodium acrylate homopolymer, 45% total solids, 4500 MW), and gluconic acid (55%). The results are shown in FIG. 1. The highest calcium complexing capacity is provided by the Acusol 445N. Based on this screening the Trilon M that was included in Example 1 Formulas 1-4 was removed for further evaluation of formulas evaluated and shown in Table 3A. The Trilon M was removed from Formula 5 and the amount of Acusol 445N was increased in Formula 6. Additional benchmark Control products were compared as shown in Table 3B above and also Control Benchmark 2 (commercial product with Acusol 445N and phosphate-containing complexing agents).

TABLE 3A

Wt-%

| Component | Formula 5 | Formula 6 |
|---|---|---|
| Water softened | 50.8 | 31.3 |
| Methyl glycine diacetic | 5 | 0 |
| acid (MGDA) | | |
| Polyacrylic acid sodium salt | 18 | 42.5 |
| Sodium gluconate | 26.2 | 26.2 |
| Total | 100% | 100% |

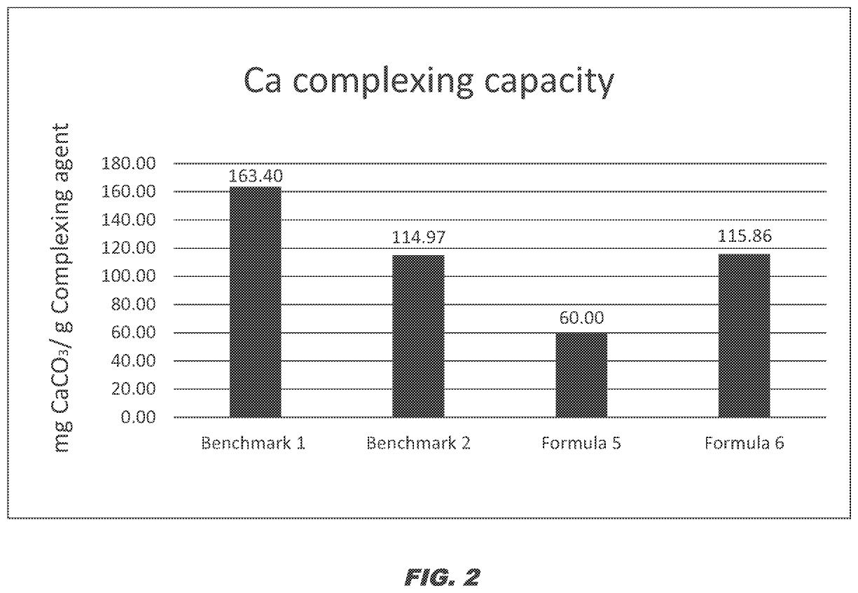

The results are shown in FIG. 2 where Formula 6 shows greatest calcium complexing capacity that is slightly better than the Benchmark 2 (competitive product with phosphate-containing complexing agents). Although the Formula 6 did not bind as high levels of calcium as Benchmark 1, it provides a high-level calcium complexing while also being phosphate-free, which provides the beneficial whiteness results over the benchmark controls.

### Example 3

Tables 4A and 4B show the results of a secondary wash test on a large washing machine in the presence of a mixture of heavy metals comparing Formulas 5-6 disclosed in Table 3A with the benchmark controls. The Y-values (whiteness) was measured after 25 wash cycles with the evaluated formulas. The washing method, water hardness, water quantity and temperatures were programmed according to the requirements of the Schulthes washing machines. The evaluated product (Formula 5 or 6, or Benchmark 1 or 2) was weighed on the laboratory scale and placed in the detergent container of the washing machine. The standard program has 3 rinse baths as well as 1 intermediate and 1-end spin. The secondary washing procedures are performed on 4-wash machines. Once the 25-wash cycles are completed the control fabrics and evaluated fabrics are ironed.

TABLE 4A

Y-Value

| | Cotton | Mixed fabric 610 |
|---|---|---|
| Benchmark 1 | 83.51 | 74.60 |
| Benchmark 2 | 81.43 | 72.95 |
| Formula 5 | 82.30 | 76.16 |
| Formula 6 | 83.18 | 75.97 |

The results of the cotton textile demonstrate that the whiteness degree (Y-Value) of Formula 6 is approximately on the same level as of Benchmark 1 (and Formula 5 is approaching that of the Benchmark 1 (and exceeds Benchmark 2)) while also providing the benefits of being phosphate-free. Both Formulas 5 and 6 show the best result (equal level) in terms of whiteness for mixed fabric 610.

Additional testing of Y-values (whiteness) was measured after 25 wash cycles in a mixed dirt test (engine oil, graphite, starch, albumin, iron, cupper) in addition to the water hardness ions.

TABLE 4B

Y-Value

| | Cotton | Mixed fabric 610 |
|---|---|---|
| Benchmark 1 | 73.44 | 57.72 |
| Benchmark 2 | 71.59 | 56.78 |
| Formula 5 | 73.12 | 56.52 |
| Formula 6 | 73.26 | 57.93 |

The results shown that for textile cotton the whiteness degree (Y-Value) of Formulas 5 and 6 is approximately the same as Benchmark 1. Formula 6 and Benchmark 1 show the best results (equal level) in terms of whiteness for mixed fabric 610. Overall the lower Y-values are consistent with the increase pressure on the laundry system with the mixed dirt test.

### Example 4

Additional Hempshire testing as outlined in Example 2 was completed to compare the Benchmarks 1 and 2 along with Formula 6 to Benchmark 3 as shown in Table 5 in terms of calcium (Ca) complexing. Benchmark 3 is a composition according to example 6 of WO2019/005940 A1.

TABLE 5
Control Benchmark 3

| Component | Wt-% |
|---|---|
| Water softened | Remainder |
| MGDA | 1.7% |
| DTPA | 4% |
| Sodium gluconate | 16% |
| Polyacrylic acid sodium salt | 16.2% |
| Total | 100% |

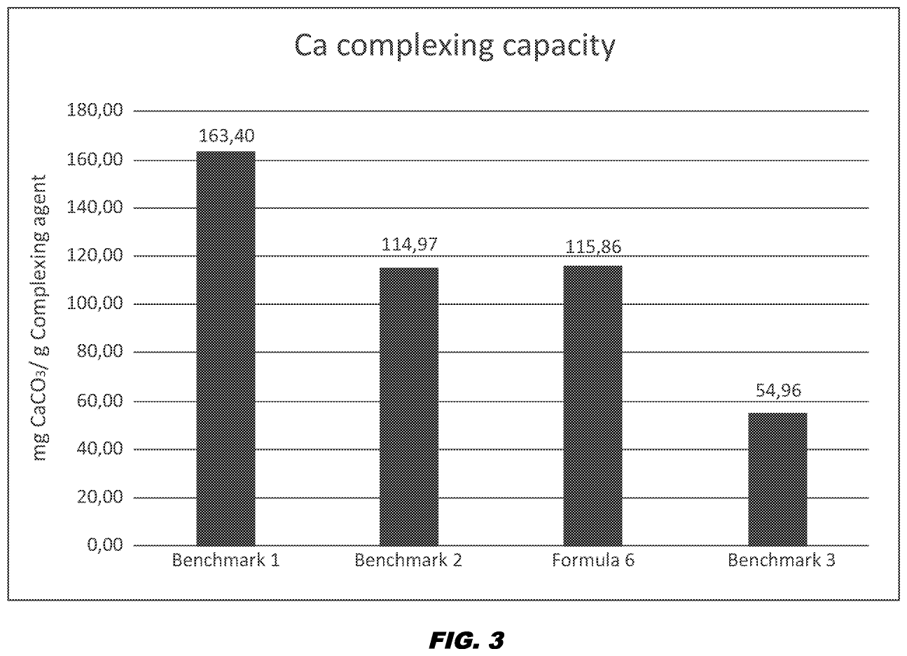

The results are shown in FIG. 3 where Formula 6 also shows significantly greater calcium complexing capacity in comparison to Benchmark 3. This is unexpected as the Benchmark 3 contains two additional chelants in addition to the gluconate chelant and the carboxylate polymer. Again, the Formula 6 provides the benefit of both being phosphate-free and also not requiring use of secondary polymer chelants, such as aminopolycarboxylate chelant (e.g. DTPA), while providing the beneficial whiteness results over the benchmark controls.

### Example 5

Additional Hempshire testing as outlined in Example 2 was completed to compare the Benchmarks 1 and 2 along with Formula 6 to Benchmark 4 as shown in Table 6 in terms of calcium (Ca) complexing.

TABLE 6
Control Benchmark 4

| Component | Wt-% |
|---|---|
| Water softened | Remainder |
| MGDA | 2.4% |
| GLUDA (glutamic acid N,N-diacetic acid) | 3% |
| Sequestrant (2-phosphonobutane-1,2,4-tricarboxylic | 2.5% |
| acid) | |
| Gluconic acid | 7.5% |
| Polyacrylic acid sodium salt | 7.3% |
| Total | 100% |

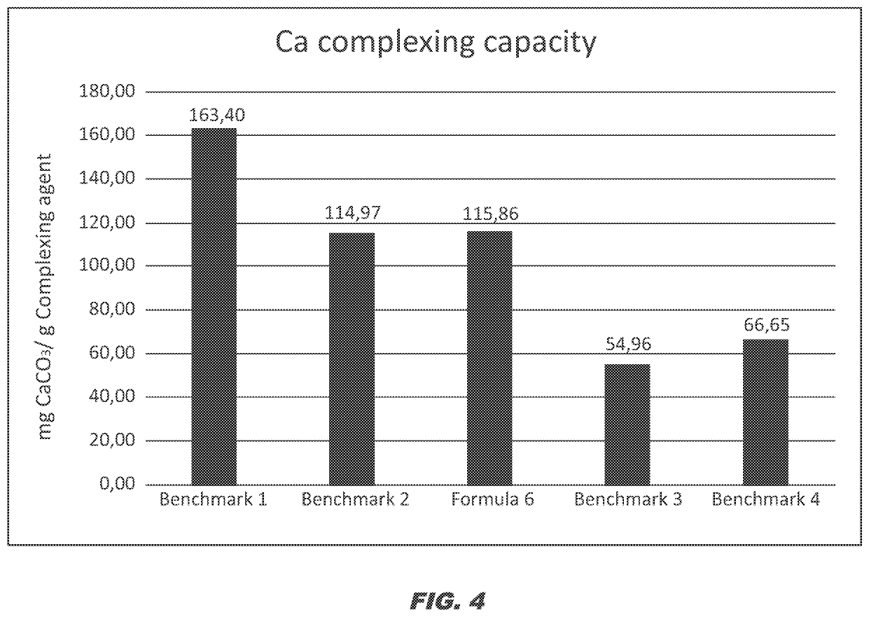

The results are shown in FIG. 4 where Formula 6 also shows significantly greater calcium complexing capacity in comparison to Benchmark 4. Again, the Formula 6 provides the benefit of both being phosphate-free and also not requiring use of secondary polymer chelants, such as aminopolycarboxylate chelant (e.g. MGDA, GLUDA), while providing the beneficial whiteness results over the benchmark controls.

### Example 6

The methodology of Example 3 was utilized to assess the Y-values (whiteness) on cotton fabrics comparing Control Benchmark 3 (shown above in Table 5) to the evaluated Formula 6. The methods assess washing under pressured conditions including high addition of heavy metals, in particular iron. Again the Y-value was determined according to DIN 5033 (German Institute for Standardization).

TABLE 7

| | | Y-Value on Cotton over number of wash cycles | | | | |
|---|---|---|---|---|---|---|
| | | 5 | 10 | 15 | 20 | 25 |
| Benchmark | Average | 83.89 | 84.11 | 84.20 | 83.99 | 83.82 |
| 3 | Std | 0.18 | 0.17 | 0.09 | 0.39 | 0.16 |
| | deviation | | | | | |
| Formula 6 | Average | 84.21 | 83.98 | 83.87 | 83.98 | 83.22 |
| | Std | 0.30 | 0.39 | 0.05 | 0.10 | 0.22 |
| | deviation | | | | | |

The results of the cotton textile demonstrate that the whiteness degree (Y-Value) of both compositions remains constant over 25 cycles. Only the measurement after 25 cycles does the Benchmark 3 formula show a minimally higher Y-value, however when factoring the standard deviation, the difference is not significant. Formula 6 provides the benefit of both being phosphate-free and also not requiring use of secondary polymer chelants, such as amino polycarboxylate chelant (e.g. DTPA), while providing the beneficial whiteness results.

### Example 7

The Hempshire method of Example 2 was utilized to assess Calcium complexing capacity with the following methods to determining the sequestering power of Fe³⁺. The ferric solution is obtained by dissolving 86.3 g of Ammonium iron (III) sulfate dodecahydrate NH₄Fe(SO₄)₂×12H₂O Merck 3776 in 1000 ml distilled water.

Method: Dissolve 10 g product in DI water in 1000 mL flask. Transfer 25 mL aliquot to a glass with 50 mL DI water. Add a known quantity of ferric solution and while stirring adjust pH to desired stating value with NaOH/H₂SO₄ solutions. Stir for 30 minutes. Adjust pH if needed. Bring total solution to 100 mL and stir for 24 hours. Maintain pH and if required adjust. After 24 hours, a ray of light is shown in the solution. The visual assessment of a precipitation (or any turbidity) or clear solution is determined by using a ray of light by a source of light (e.g. torch). As soon as there is noticeable weak turbidity, the ray of light will be visible as line of light.

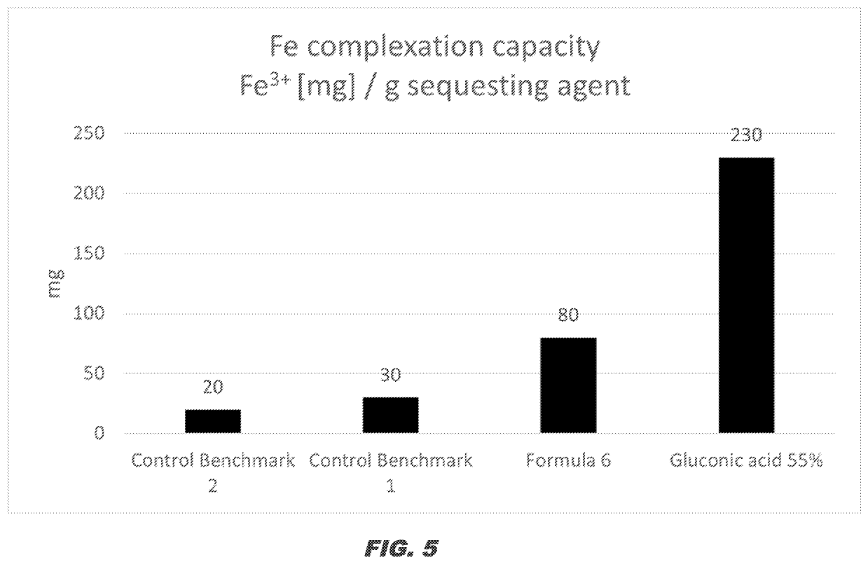

The sequestering agents in Table 8 were evaluated and the results are shown in FIG. 5 and summarized in Table 8.

TABLE 8
Sequestering Power of Fe³⁺

| | Ferric Solution | Complexation |
|---|---|---|
| | Reagent | Capacity Fe³⁺(mg)/ |
| Sequestering Agent | Used (mL) | Sequestering Agent (g) |
| Control Benchmark 2 | 0.50 | 20 |
| Control Benchmark 1 | 0.75 | 30 |
| Formula 6 | 2.00 | 80 |
| Gluconic acid 55% | 5.75 | 230 |
| (Raw Material in Formula 6) | | |

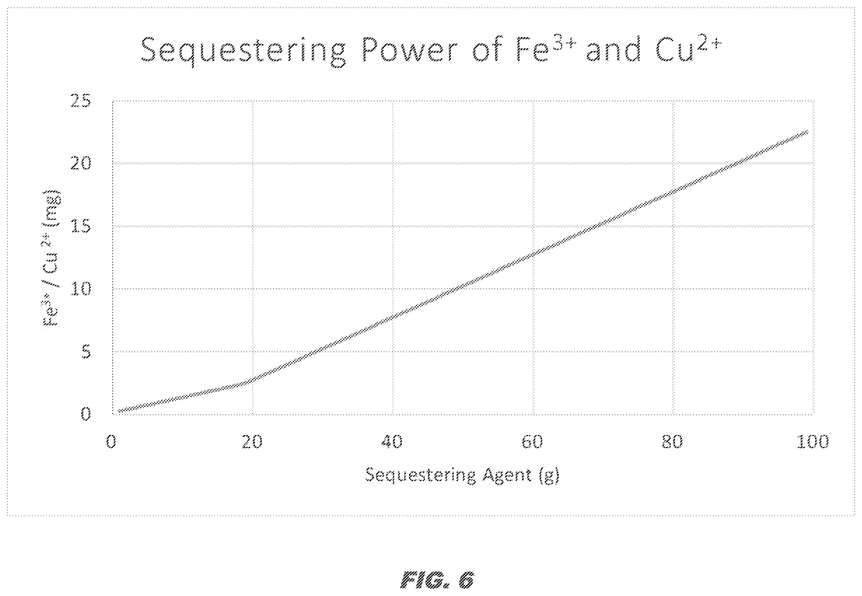

Further FIG. 6 shows the graphical results of the sequestering capability of Fe³⁺/Cu²⁺ (mg). The determination of the sequestering power of Fe³⁺/Cu²⁺, as shown in FIG. 6 were calculated based on x mg Fe³⁺/g sequestering agent=x ml ferric solution (86.3 g/l NH₄Fe(SO₄)₂·12H₂O or x mg Cu²⁺/g sequestering agent=x ml copper solution (39.3 g/l CUSO₄·5H₂O.

The results show that laundry booster composition controls water hardness and metal contaminates, namely controls the water in the initial wash process that is hard water and/or water contaminated with metals. This further demonstrates how the enhanced whiteness in laundry is achieved.

The inventions being thus described, it will be obvious that the same may be varied in many ways. Such variations are not to be regarded as a departure from the spirit and scope of the inventions and all such modifications are intended to be included within the scope of the following claims. The above specification provides a description of the manufacture and use of the disclosed compositions and methods. Since many embodiments can be made without departing from the spirit and scope of the invention, the invention resides in the claims.

What is claimed is:

1. A method for treating laundry comprising the step of:
contacting the laundry with a laundry booster composition comprising:
from about 15 wt-% to about 40 wt-% of a gluconate chelant;
from about 25 wt-% to about 50 wt-% of a carboxylate polymer; and
from about 20 wt-% to about 50 wt-% of water;
wherein the laundry booster composition is phosphorus-free and free of phosphorus-containing compounds, controls water hardness and metal contaminants throughout the laundry process, and provides enhanced whiteness of the treated laundry, and
wherein the laundry booster compositions follows an initial wash process where the laundry is contaminated with metals and/or where the water supplied to the washer is hard water and/or contaminated with metals.

2. The method of claim 1, further comprising a rinse cycle following the initial wash process and the laundry booster step.

3. The method of claim 1, wherein the wastewater from the laundry does not contain phosphorus.

4. The method of claim 1, wherein the laundry booster composition consists of the gluconate chelant, the carboxylate polymer and water.

5. The method of claim 1, wherein the dosing of the laundry booster composition is provided at a rate of: (a) about 0.5 fluid ounces to about 30 fluid ounces (about 14.79 mL to about 887.1 mL), or (b) about 3 fluid ounces to about 30 fluid ounces (about 88.71 mL to about 887.1 mL) per 100 pounds of linen, or (c) at a rate to control the transition metals contained at a concentration of at least 0.1 ppm in the laundry process.

6. The method of claim 1, wherein the dosing of the laundry booster composition is provided at a rate of about 0.5 to about 5 grams/L of a solution of the water conditioning composition, and wherein the composition comprises from about 0.08 to about 0.8 grams/L of the gluconate chelant.

7. The method of claim 1, wherein the contacting of the laundry additive composition is: before a bleaching and/or oxidizing step in the laundry process; and/or simultaneous with an alkaline detergent wash step in the laundry process.

8. The method of claim 1, wherein the laundry booster composition is dosed into the washing machine.

9. A liquid laundry booster composition comprising:
from about 15 wt-% to about 40 wt-% of a gluconate chelant;
from about 25 wt-% to about 50 wt-% of a carboxylate polymer; and
from about 20 wt-% to about 50 wt-% of water,
wherein the composition is phosphorus-free and free of phosphorus-containing compounds.

10. The composition of claim 9, wherein the gluconate chelant is sodium gluconate or gluconic acid.

11. The composition of claim 9, wherein the carboxylate polymer is a polyacrylate polymer, a polyacrylic acid, a polymaleic acid, salt thereof or combination thereof of two or more of the carboxylate polymers.

12. The composition of claim 9, further comprising an aminocarboxylate chelant.

13. The composition of claim 12, wherein the aminocarboxylate chelant is methyl glycine diacetic acid.

14. The composition of claim 9, wherein no additional chelants are included in the composition.

15. The composition of claim 9, wherein the gluconate chelant comprises from about 15 wt-% to about 30 wt-% of the composition, wherein the carboxylate polymer comprises from about 30 wt-% to about 50 wt-% of the composition, and water comprises from about 20 wt-% to about 40 wt-% of the composition.

16. The composition of claim 9, wherein the composition is free of surfactants and/or free of diethylenetriaminepentaacetic acid.

17. A liquid laundry booster composition consisting of:
from about 15 wt-% to about 40 wt-% of a gluconate chelant;
from about 25 wt-% to about 50 wt-% of a carboxylate polymer; and
from about 20 wt-% to about 50 wt-% of water,
wherein the composition is phosphorus-free.

18. The composition of claim 17, wherein the gluconate chelant is sodium gluconate or gluconic acid and wherein the carboxylate polymer is a polyacrylate polymer, a polyacrylic acid, a polymaleic acid, salt thereof or combination thereof of two or more of the carboxylate polymers.

19. The composition of claim 17, further comprising an aminocarboxylate chelant.

20. The composition of claim 17, wherein the gluconate chelant comprises from about 15 wt-% to about 30 wt-% of the composition, wherein the carboxylate polymer comprises from about 30 wt-% to about 50 wt-% of the composition, and water comprises from about 20 wt-% to about 40 wt-% of the composition.
